(19) United States
(12) Patent Application Publication
(10) Pub. No.: US 2010/0125720 A1
(43) Pub. Date: May 20, 2010

(54) INSTRUCTION MODE IDENTIFICATION APPARATUS AND METHOD

(76) Inventor: Jan Sheng-Yuan, Chiayi City (TW)

Correspondence Address: VEDDER PRICE P.C., 222 N. LASALLE STREET, CHICAGO, IL, 60601, US

(21) Appl. No.: 12/615,836

(22) Filed: Nov. 10, 2009

(30) Foreign Application Priority Data
Nov. 14, 2008 (TW) 097144130

(51) Int. Cl. G06F 9/30; G06F 9/38

(52) U.S. Cl. 712/205; 712/229; 712/E09.016; 712/239; 712/E09.045; 712/208

(57) ABSTRACT

An instruction mode identification apparatus includes a program counter and a processor. The program counter stores an instruction address, which comprises a plurality of bits for indicating an address of an instruction currently executed or to be executed. At least one of the plurality of bits is a redundant bit. The processor identifies an instruction mode according to the redundant bit. The instruction mode represents an execution mode of the current instruction. An instruction mode identification method is also disclosed.

### CROSS-REFERENCE TO RELATED APPLICATION

This application claims priority of Taiwanese Application No. 097144130, filed on Nov. 14, 2008.

### BACKGROUND OF THE INVENTION

1. Field of the Invention

The invention relates to an instruction mode identification apparatus and method, more particularly to an instruction mode identification apparatus and method for use in a processor.

2. Description of the Related Art

A typical processor executes instructions in different instruction modes according to different instruction set architectures (ISAs). The most common processors are the 16-bit processor (e.g., Intel® 8086 and 80286, and Motorola® M6800), which are capable of processing and executing all instructions in a 16-bit instruction set, and the 32-bit processor (e.g., Intel® Pentium® Pro), which is capable of processing and executing all instructions in a 32-bit instruction set.

However, for present-day applications, a processor is generally no longer restricted to processing a single ISA. For example, the ARM9TDMI® processor (http://www.arm.com) is a 32-bit processor, yet it can process and execute a 16-bit thumb instruction set. That is, the ARM9TDMI® processor can support both 32-bit and 16-bit instruction modes.

Such processors that support two kinds of instruction set modes determine the instruction mode of an instruction currently being processed according to an instruction set mode register or an instruction set mode bit installed therein.

Referring to FIG. 1, using a MIPS® processor (http://www.mips.com) as an example, the processor may be divided into five portions of an instruction fetch (IF) stage 11, an instruction decode (ID) stage 12, an instruction execution (IE) stage 13, a memory access (MA) stage 14, and a write back (WB) stage 15. The stages 11 to 15 are connected in series in accordance with the operating sequence of instruction fetch, instruction decode, instruction execution, memory access, and write back to thereby form a pipeline processor with a 5-stage pipeline architecture.

With respect to any one point in time, and assuming no data hazard, the aforementioned processor can process five instructions simultaneously. However, since each pipeline stage shares the same instruction mode register 16, the instruction in each pipeline stage must be of the same instruction mode. That is, the 5-stage pipeline is unable to process two or more types of instruction modes at any one point in time.

For example, when a MIPS processor intends to convert its instruction mode from MIPS32 to MIPS16, through an execution jump instruction (JALX or JR in a MIPS16 instruction set), the instruction execution stage 13 first changes an address stored in a program counter 17, such that the MIPS processor is able to jump to another address and fetch a subsequent instruction according to the program counter 17. Subsequently, the write back stage 15 writes a value indicating a MIPS16 instruction architecture into the instruction mode register 16, such that each pipeline stage starts with the next instruction to execute the MIPS16 mode.

Referring to FIG. 2, in an instruction execution cycle, after a jump instruction JALX is executed, it is necessary to wait for a delay cycle (instruction A) so that the next instruction can still be executed according to the original instruction mode. However, since the instruction decode stage 12 can determine the correct instruction mode for performing an instruction decode operation only after the write back stage 15 sets up the instruction mode register 16, it is necessary to wait three instruction cycles (instruction D) before the switching operation to MIPS16 mode is done correctly. Therefore, even when the delay cycle is not taken into consideration, two additional instruction cycles (instruction B and instruction C) are required for completion of such a switching operation. For a higher-level processor, to increase efficiency, the number of pipeline stages is increased accordingly, or a super-scalar architecture is used. Hence, when the number of pipeline stages between the instruction stage 13 and the write backstage 15 is increased, the number of required instruction cycles is similarly increased.

The disadvantages for the aforementioned conventional design and method may be summarized as follows:

1) At any one point in time, two or more types of instruction modes cannot be simultaneously processed within a pipeline; and

2) When a processor switches instruction mode, two or more instruction cycles are required to complete the switching operation, thereby adversely affecting the efficiency of instruction execution.

### SUMMARY OF THE INVENTION

Therefore, the object of the present invention is to provide an instruction mode identification apparatus comprising: a program counter storing an instruction address, the instruction address including a plurality of bits for indicating an address of an instruction currently executed or to be executed, at least one of the plurality of bits being a redundant bit; and a processor identifying an instruction mode according to the redundant bit, the instruction mode representing an execution mode of the current instruction.

It is another object of the present invention to provide an instruction mode identification method comprising: storing an instruction address by a program counter, the instruction address including a plurality of bits for indicating an address of an instruction currently executed or to be executed, at least one of the plurality of bits being a redundant bit; and identifying an instruction mode by a processor according to the redundant bit, the instruction mode representing an execution mode of the current instruction.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of a conventional instruction mode identification apparatus;

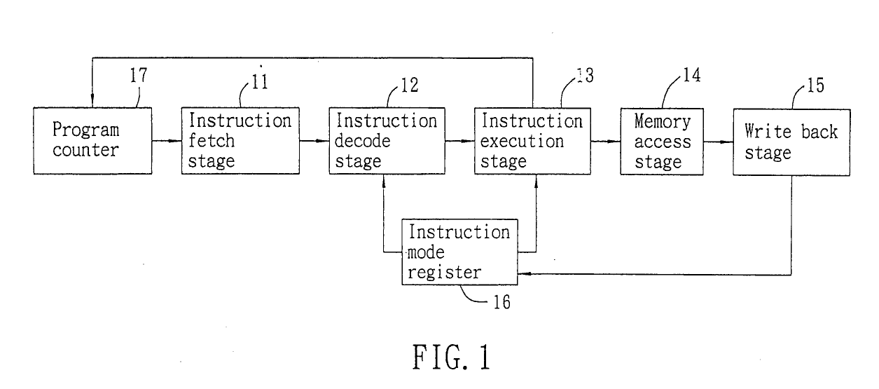

FIG. 2 is a schematic diagram of instruction cycles during conventional instruction mode switching;

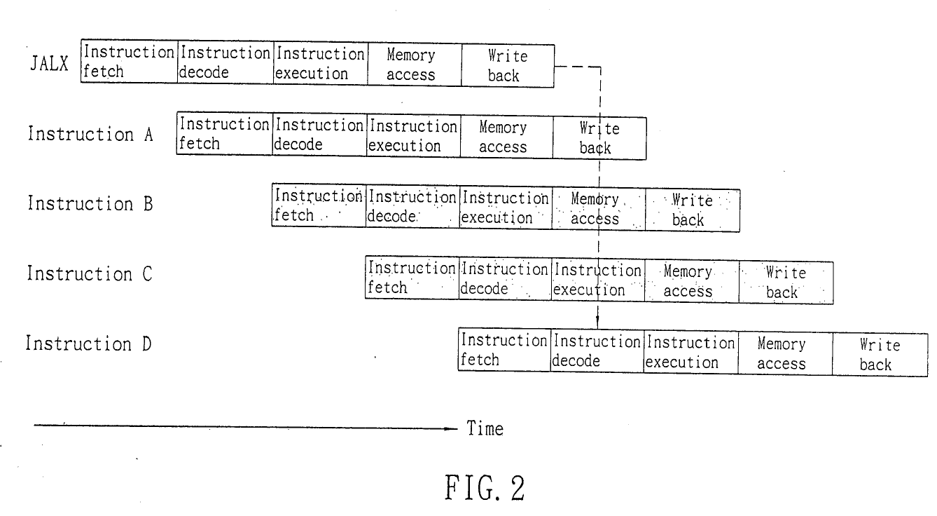

FIG. 3 is a schematic diagram of a program counter of an instruction mode identification apparatus according to a preferred embodiment of the present invention;

FIG. 4 is a schematic circuit block diagram of the preferred embodiment;

FIG. 5 is a schematic diagram of instruction cycles during instruction mode switching according to the preferred embodiment; and

FIG. 6 is a flowchart of the preferred embodiment of an instruction mode identification method according to the present invention.

### DETAILED DESCRIPTION OF THE PREFERRED EMBODIMENT

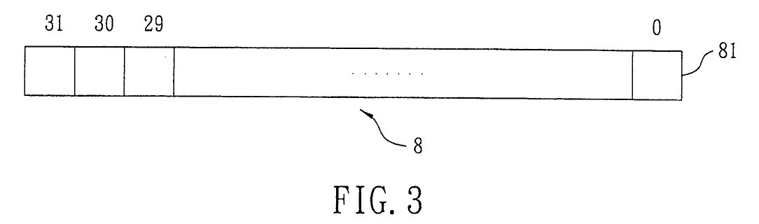

Referring to FIG. 3, the preferred embodiment of an instruction mode identification apparatus according to the present invention includes a program counter 8 for storing an address that includes a plurality of bits, at least one of which is a redundant bit 81. That is, at least one bit in the address stored in the program counter 8 is unalterable or undefined. For example, with respect to a 32-bit processor, since the smallest unit for memory access is a word, to fetch a subsequent instruction, the address stored in the instruction mode register 16 is automatically incremented by four (for instance, if the binary address of the first instruction is 0000_{b}, then the binary address of the second instruction is 0100_{b}, the binary address of the third instruction is 1000_{b}, etc.). Therefore, for the program counter 8, the last two bits are fixed to be 00_{b}, and hence in this example, the last two bits are redundant bits.

With such a characteristic, the constant bits in the program counter 8 are used as the redundant bit 81 in this embodiment. Hence, when a processor intends to change the instruction mode, the redundant bit 81 of the program counter 8 can be set so as to serve as a basis for determining different instruction modes.

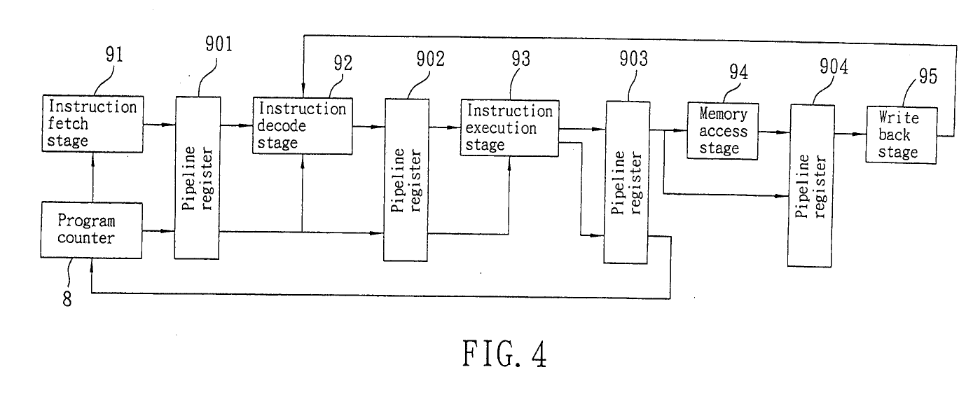

For example, referring to FIG. 4, when applied to a MIPS processor with a 5-stage pipeline, the instruction mode identification apparatus of this invention includes an instruction fetch stage 91, an instruction decode stage 92, an instruction execution stage 93, a memory access stage 94, a write back stage 95, and the program counter 8. Further, a pipeline register 901-904 is disposed between each pair of stages for temporary storage of a processing result of each stage, and transmission of the processing result to the next stage in the subsequent instruction cycle. To simplify the description to follow, an explanation of the operation of the pipeline registers 901-904 is omitted in the following description.

Based on the address stored in the program counter 8, the instruction fetch stage 91 retrieves the instruction corresponding to the address from a memory, and then transmits the retrieved instruction and the address stored the program counter 8 to the instruction decode stage 92. The instruction decode stage 92 determines to which instruction mode the instruction to be presently decoded belongs according to the redundant bit 81 of the address stored in the program counter 8, and then proceeds with a corresponding decoding operation. After decoding is completed, the corresponding control signal generated and the address stored in the program counter 8 are sent to the instruction execution stage 93. The instruction execution stage 93 determines to which instruction mode the instruction to be presently executed belongs according to the redundant bit 81 of the address stored in the program counter 8, and executes the instruction and also updates the address stored in the program counter 8 according to the control signal. After execution, the result of the executed instruction is sent to the memory access stage 94, and the updated address of the program counter 8 is sent to the instruction fetch stage 91 for use in retrieving a subsequent instruction.

The memory access stage 94 stores the executed result in the memory or reads data from the memory according to the corresponding instruction. Lastly, the write back stage 95 resets the instruction decode stage 92 for execution of subsequent instructions.

In this example, since the MIPS processor is a 32-bit processor, when fetching a subsequent instruction, the address stored in the program counter 8 is incremented by 4 or 2. Therefore, the last bit of the program counter 8 is fixed to 0, and this bit is consistent with the aforementioned definition of an invariable bit being considered as a redundant bit.

Therefore, in this example, when the instruction mode is to be switched to MIPS16, the instruction execution stage 93 sets the last bit of the program counter 8 to 1. That is, when the instruction mode of the current instruction is MIPS32, the corresponding last bit of the instruction address stored in the program counter 8 (least significant bit, LSB) must be 0, and when the instruction mode of the current instruction is MIPS16, the corresponding last bit of the instruction address stored in the program counter 8 must be 1.

It is to be noted that, the processor can define 2^{M} different instruction modes using the bit number (M) of the redundant bits 81 according to the requirements with respect to the number of the instruction modes. In the aforementioned example, the program counter 8 has two redundant bits 81, and hence, the state in which the redundant bits 81 have a value of 00 may be defined as representing the MIPS32 instruction mode, the state in which the redundant bits 81 have a value of 01 may be defined as representing the MIPS16 instruction mode, the state in which the redundant bits 81 have a value of 10 may be defined as representing a third instruction mode, and the state in which the redundant bits 81 have a value of 11 may be defined as representing a fourth instruction mode.

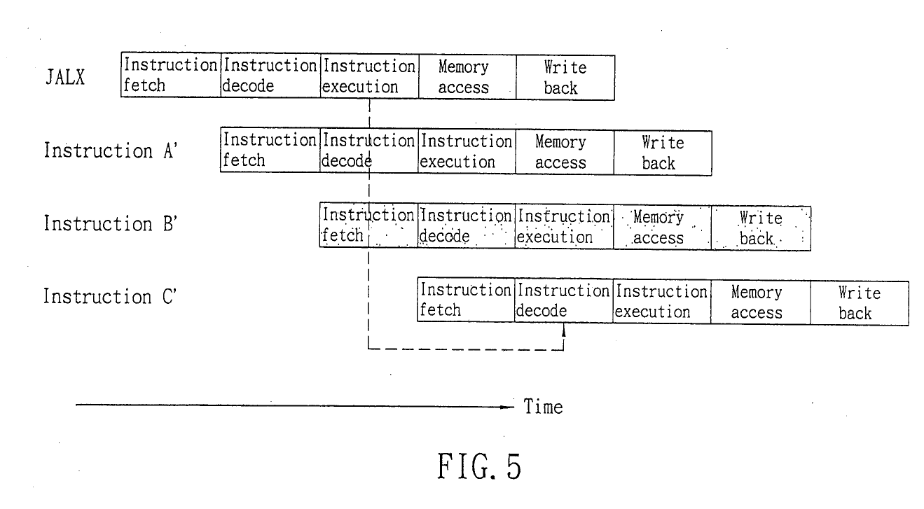

Referring to FIG. 5, from the point of view of the instruction execution cycle, after the jump instruction JALX is executed, it is necessary to wait for a delay cycle (instruction A′) so that the next instruction can still be executed according to the original instruction mode. However, unlike with the prior art method, since the instruction execution stage 93 sends the updated address stored in the program counter 8 to the instruction fetch stage 91 during the next instruction cycle (instruction B′), the instruction decode stage 92 is able to read the correct address of the program counter 8 during the next instruction cycle (instruction C′). Therefore, the current instruction mode is determined to be MIPS16 or MIPS32 according to the last bit of the program counter 8.

Since the operation of updating the address stored in the program counter 8 (including the operation of setting the last bit of the program counter 8) is completed in the instruction execution stage 93, the number of instruction cycles required is always 1, even when the present invention is applied to a higher level processor or a processor with a larger number of pipeline stages. This number of instruction cycles is also not increased with an increase in the number of the pipeline stages between the instruction execution stage 93 and the write back stage 95. Hence, the instruction mode identification apparatus of this invention is capable of reducing to a minimum the number of instruction cycles required during instruction mode switching.

Moreover, at any one point in time, the address of the program counter 8 on which each pipeline stage bases its operation on is different (and is the address stored in the corresponding pipeline register during the previous instruction cycle). For instance, the address of the program counter 8 on which the instruction fetch stage 91 bases its operation on is the most current or an updated address, and the address of the program counter 8 on which the instruction decode stage 92 bases its operation on is the address of the program counter 8 on which the instruction fetch stage 91 based its operation on in the previous instruction cycle. Similarly, the address of the program counter 8 on which the instruction execution stage 93 bases its operation on and the address of the instruction fetch stage 91 differ by two instruction cycles. Therefore, the instruction fetch stage 91, the instruction decode stage 92, and the instruction execution stage 93 are capable of executing instructions in different instruction modes at any one point in time. This allows the mixed use of instruction sets of MIPS16 and MIPS32 in an efficient manner. Moreover, when processing is performed to the point where it is necessary to call an external programming library, frequent instruction mode switching may be needed due to the difference between the instruction mode of the external programming library and the instruction mode of the main program code. Through the present invention, the number of instruction cycles required as a result of frequent instruction mode switching can be reduced to a minimum, thereby significantly enhancing the execution efficiency of program codes.

It is to be noted that the redundant bit 81 of the program counter 8 is not necessarily the last bit of the program counter 8 as described above. As long as the bit is undefined in the program counter 8 or is defined but has a value that does not vary, it can be used as a redundant bit that indicates different instruction set modes.

The instruction mode identification disclosed by this invention has many applications. Taking the application to branch prediction as an example, since branch prediction is used to process the calculations of a program counter, in a state where there is a redundant bit, the aforesaid advantages can be realized in the execution thereof.

In Table 1 below, which lists data related to efficiency when this invention is applied to a MIPS processor, the first column shows relevant data in the execution of a segment of a program code all in the MIPS32 instruction set mode. The second column in Table 1 shows relevant data in the processing of sub-segments of a program code in either the MIPS32 instruction mode or MIPS16 instruction mode according to whether execution efficiency requirements of sub-segments of a program code are high or low, in which the mode switching of MIPS32/MIPS16 is determined according to an internal instruction mode register (or an instruction mode bit), i.e., the conventional design method is utilized. Lastly, the third column in Table 1, which is related to the instruction mode identification apparatus of this invention, shows relevant data in the processing in either the MIPS32 instruction mode or MIPS16 instruction mode according to whether execution efficiency requirements of sub-segments of a program code are high or low. It is to be noted that the data of program code size and execution time are those after undergoing normalization.

TABLE 1

| | | MIPS32/MIPS16 | MIPS32/MIPS16 |
|---|---|---|---|
| | | (Prior art | (Method of |
| | MIPS32 | method) | present invention) |
| Program code size | 1.5 KB | 1.06 KB | 1.06 KB |
| (Normalized) | | | |
| execution | 1 | 1.31 | 1.23 |
| time (Normalized) | | | |

It is evident from the data of Table 1 that through use of the instruction mode identification apparatus of this invention, the originally used MIPS16 instruction mode may be maintained to compress the size of the program code, and at the same time, the number of the required instruction cycles may be reduced to a minimum (i.e., to 1), such that the time required for program execution may be reduced over the conventional methods. Moreover, since no additional instruction mode register or instruction mode bit is needed, no extra hardware costs are involved. The instruction mode identification apparatus and method of this invention are suitable for any program counter with redundant bits, and are not restricted to application to a MIPS processor as described above.

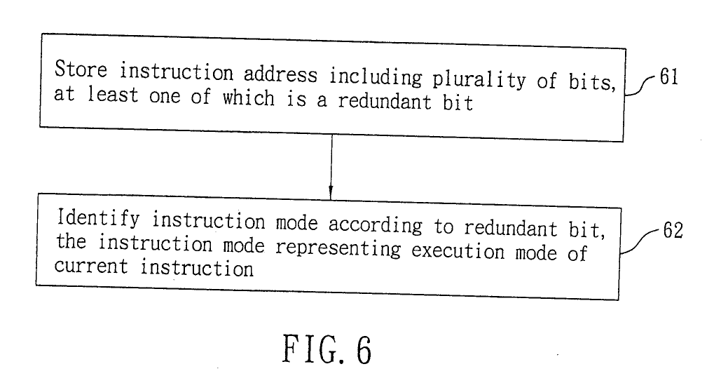

Referring to FIG. 6, the preferred embodiment of an instruction mode identification method according to this invention is used in an N-stage pipeline processor and comprises the following steps:

In step 61, the processor uses a program counter to store an instruction address, the instruction address including a plurality of bits to indicate an address of an instruction currently being executed or to be executed. At least one bit among the plurality of bits is a redundant bit.

In step 62, the processor identifies an instruction mode according to the redundant bit, in which the instruction mode represents the execution mode of the current instruction.

In sum, the instruction mode identification apparatus and method of this invention have the following advantages:

1) At any one point in time, two or more types of instruction modes can be processed in a pipeline;

2) Regardless of the pipeline architecture of the processor, only one instruction cycle is required in order to complete an instruction mode switching operation; and

3) The pre-existing redundant bit in the program counter is used for identification of different instruction modes, so there are no extra hardware costs.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An instruction mode identification apparatus comprising:
a program counter, storing an instruction address, the instruction address including a plurality of bits for indicating an address of an instruction currently executed or to be executed, at least one of the plurality of bits being a redundant bit; and
a processor, identifying an instruction mode according to the redundant bit, the instruction mode representing an execution mode of the current instruction.

2. The instruction mode identification apparatus of claim 1, wherein the redundant bit is indicated by a single bit, and the redundant bit is set to be one of 0 and 1 to represent one of two types of instruction modes.

3. The instruction mode identification apparatus of claim 1, wherein the redundant bit is indicated by an M-number of bits for representing 2^{M} instruction modes.

4. The instruction mode identification apparatus of claim 1, wherein the redundant bit is a bit in the instruction address that is undefined or has a value that does not vary.

5. The instruction mode identification apparatus of claim 1, wherein the processor has an N-stage pipeline architecture, the processor requiring at most one instruction cycle when the processor switches from a first instruction mode to a second instruction mode.

6. The instruction mode identification apparatus of claim 1, wherein the processor has an N-stage pipeline architecture that comprises an instruction decode stage and an instruction execution stage, the instruction decode stage generating the instruction mode according to the redundant bit, and the instruction execution stage executing instructions according to the instruction mode.

7. The instruction mode identification apparatus of claim 6, wherein the processor further includes an instruction fetch stage for retrieving instructions to be executed.

8. The instruction mode identification apparatus of claim 7, wherein the instruction fetch stage, the instruction decode stage, and the instruction execution stage respectively fetch, decode, and execute instructions according to the instruction address in the program counter.

9. The instruction mode identification apparatus of claim 1, wherein the processor has an N-stage pipeline architecture, and the instruction execution stage sets the redundant bit to a corresponding value when the processor switches from a first instruction mode to a second instruction mode.

10. The instruction mode identification apparatus of claim 1, wherein the program counter processes content therein using branch prediction.

11. An instruction mode identification method comprising:
storing an instruction address by a program counter, the instruction address including a plurality of bits for indicating an address of an instruction currently executed or to be executed, at least one of the plurality of bits being a redundant bit; and
identifying an instruction mode by a processor according to the redundant bit, the instruction mode representing an execution mode of the current instruction.

12. The instruction mode identification method of claim 11, wherein the redundant bit is indicated by a single bit, and the redundant bit is set to be one of 0 and 1 to represent one of two types of instruction modes.

13. The instruction mode identification method of claim 11, wherein the redundant bit is indicated by an M-number of bits for representing 2^{M} instruction modes.

14. The instruction mode identification method of claim 11, wherein the redundant bit is a bit in the instruction address that is undefined or has a value that does not vary.

15. The instruction mode identification method of claim 11, wherein the processor has an N-stage pipeline architecture, the processor requiring at most one instruction cycle when the processor switches from a first instruction mode to a second instruction mode.

16. The instruction mode identification method of claim 11, wherein the processor has an N-stage pipeline architecture that comprises an instruction decode stage and an instruction execution stage, the instruction decode stage generating the instruction mode according to the redundant bit, and the instruction execution stage executing instructions according to the instruction mode.

17. The instruction mode identification method of claim 16, wherein the processor further includes an instruction fetch stage for retrieving instructions to be executed.

18. The instruction mode identification method of claim 17, wherein the instruction fetch stage, the instruction decode stage, and the instruction execution stage respectively fetch, decode, and execute instructions according to the instruction address in the program counter.

19. The instruction mode identification method of claim 11, wherein the processor has an N-stage pipeline architecture, and the instruction execution stage sets the redundant bit to a corresponding value when the processor switches from a first instruction mode to a second instruction mode.

20. The instruction mode identification method of claim 11, wherein the program counter processes content therein using branch prediction.
